(19) United States
(12) Patent Application Publication
(10) Pub. No.: US 2009/0027934 A1
(43) Pub. Date: Jan. 29, 2009

(54) Electric Transformer-Rectifier

(76) Inventor: Juan Pablo Robledo Bustos, Santiago (CL)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/124,840

(22) Filed: May 21, 2008

(30) Foreign Application Priority Data
May 22, 2007 (CL) 1448-2007

(51) Int. Cl. H02M 7/155

(52) U.S. Cl. 363/126

(57) ABSTRACT

An electric transformer-rectifier is provided such that electrical current is supplied from a three phase alternating current supply. The device includes a tri-phase transformer, where each secondary winding has its terminals available to connect to their respective secondary windings. Power is supplied to a set of three boost converters, which in turn supply power to a set of three banks. In embodiments of the invention a set of three full wave mono-phase rectifiers, connected to the respective secondary wirings, supply power to respective capacitors banks and a three buck converter. Further the device produces continuous current to the load and sinusoidal input current in each winding of the transformer. By this invention it is possible to build a power converter in which incoming voltages and currents are approximately sinusoidal and the outgoing voltages are approximately constant.

### TECHNICAL PROBLEM

The copper industry uses electric current transformer-rectifiers in order to produce high purity copper from a circulating electrolyte where the copper is dissolved. The rectifier transformers produce a continuous electrical current that is injected into the electrolyte cells. The plant, called cell-house, consists of several electrolyte cells.

The transformer-rectifiers currently used are generally multipulse transformers that are implemented using transformers which coils operate out of phase in time each other. The objective of this configuration is to reduce the content of harmonics in the primary current. Nonetheless, the secondary currents and the magnetic fluxes from the transformer are not sinusoidal. Thus, the transformers are large, complex, expensive, inefficient, and, because they must be designed to supply power to a specific cell-house with a very narrow voltage range (constant number of cells in the cell-house), hard to replace when they fail. Normally, a tap changer is included to make the transformer more adaptable, but it increases its the costs.

Another inconvenience to be solved when classical transformer-rectifiers are used is the fact that their semiconductors (thyristors and diodes) tend to switch off due to natural commutation. This causes that the maximum conduction period for each secondary-side star semiconductors and windings is reduced to 60 electrical degrees. Thus, the maximum current that appears in these devices increases noticeably along with the effective value that they must withstand. All these issues are solved by incorporating an inductor known as an “interface reactor” into the configuration of the rectifier transformer. Thus, each semiconductor of the secondary-side stars is able to conduct current by 120 electrical degrees. However, the interface reactors raise even more the costs of the transformers.

An alternative that is currently available is the use of AFE (Active Front End) rectifier transformer-rectifiers. They are voltage elevators, and under normal operating conditions, they generate a continuous outgoing voltage and current with sinusoidal incoming voltages, currents and flows. However, these devices are not completely controlled. When the voltage in the load is low, their behavior is similar to diode rectifier transformers, thereby generating harmonic components in the tranformer's currents and magnetic flows.

The currently used transformer-rectifiers generate a set of technical problems that must be solved:
Harmonic components are generated in the currents and magnetic flows of the transformers.
Control ranges are limited and/or reactive components are generated.
Complexity in design and construction of the used transformers.
Transformers used in these devices have elevated losses in the windings and cores (elevated K-factor).
High costs for transformers.
The transformers are designed to fit a specific plant.
In cases of failure, the transformers are difficult to replace.
Harmonic filters should be incorporated into the transformers.

The general technical problem to be solved consists in finding a schema to implement a transformer-rectifier that produces a continuous outgoing current and sinusoidal incoming current with a very simple, standard, easy-to-replace, completely controlled transformer that can be used in plants with different voltages and with similar or lower costs than the solutions currently used.

### PROPOSED SOLUTION

The proposed solution is based on the fact that the instantaneous tri-phase power of a tri-phase system is a constant value when electric variables (voltages and currents) are sinusoidal¹. This clearly indicates that it is possible to build a power converter in which the incoming voltages and currents are approximately sinusoidal and the outgoing voltages and currents are approximately constant². ¹ This is shown later in this text with a mathematic demonstration.² The invention is precisely the physical and conceptual implementation of this fact.

The invention that is claimed is a controlled electric current transformer-rectifier with sinusoidal incoming current and continuous outgoing current.

### Conceptual Implementation

A monophase rectifier, in the positive quadrant, conduces the whole outgoing voltage from a transformer, which has a sinusoidal waveform. Therefore, it is possible to use the outgoing voltage of this monophase rectifier as a source for extracting electrical current throughout the entire voltage range. If the instantaneous sinusoidal voltage of the transformer is lower than the voltage in the load, then a voltage boost converter is used to extract the electrical current from the phase to the load. On the other hand, if the instantaneous sinusoidal voltage in the transformer is higher than the voltage in the load, then a voltage buck converter is used to extract the electrical current from the phase to the load.

Voltage boost and buck converters are power electronics devices that generate an output by modulating the input. In the field of power electronics, this modulation technique is known as “pulse width modulation” (PWM).

If the converters extract sinusoidal current from the transformer, then the magnetic flow in the transformer will be sinusoidal.

If the converters extract sinusoidal current from each of the three phases of the transformer, then the outgoing currents from the converters will be periodic waveforms proportional to squared sinusoidal functions and, therefore, the sum of the outgoing currents of the three converters will be a direct current with a constant value³. ³ This is shown later in this document.

### Physical Implementation

Physically, the item is a device composed of the following devices:
1. A conventional power transformer designed for sinusoidal voltages, currents, and flows.
2. A monophase full-wave rectifier (for each magnetic phase of the transformer) connected in bridge or star configuration, according to the connection of the secondary transformer.
3. A PWM-controlled voltage buck converter (for each magnetic phase of the transformer) which is supplied by a monophase full wave rectifier and the outgoing current is injected into the load.
4. A PWM-controlled voltage boost converter (for each magnetic phase of the transformer) which is supplied by a monophase full wave rectifier, and feeds the voltage buck converter.

The duty cycle is the relationship that defines the PWM converters. The duty cycle defines the fraction of time that the switch of the elemental voltage converter is turned on, that is:

$$D = \frac{{T}_{ON}}{{T}_{ON} + {T}_{OFF}} = \frac{{T}_{ON}}{{T}_{TOTAL}} = {T}_{ON} \times f$$

where T_{ON} is the time in which the switch is turned on, T_{OFF} is the time in which the switch is turned off, T_{TOTAL} is the complete time period defined as the reciprocal of the frequency f defined in Hertz (cycles per second).

### Boost Converter

The voltage boost converter operates when the incoming voltage is lower than the voltage in the load. Its basic schema consists of a capacitor bank, a controlled switch, a diode, and an inductor (FIG. 5).

The duty cycle of a voltage boost converter is not necessarily constant and corresponds to the difference between 1 and the quotient between the input voltage and the output voltage or the difference between 1 and the quotient between the outgoing current and the incoming current of the boost converter:

$$D ( t ) = 1 - \frac{{V}_{IN} ( t )}{{V}_{OUT}} = 1 - \frac{{I}_{OUT} ( t )}{{I}_{IN} ( t )}$$

### Buck Converter

The buck converter operates when the incoming voltage is higher than the load voltage. Its basic schema consists of a capacitor bank, a controlled switch, a diode, and an inductor (FIG. 4).

The duty cycle of the voltage buck converter is not necessarily constant and corresponds to the quotient between the outgoing voltage and the incoming voltage or the quotient between the incoming current and the outgoing current of the buck converter:

$$D ( t ) = \frac{{V}_{OUT} ( t )}{{V}_{IN} ( t )} = \frac{{I}_{IN} ( t )}{{I}_{OUT} ( t )}$$

### DEVICE OPERATION

The device operation can be described through the value of the quantities in different stages.

### Electrical Quantities in the Load

The typical load of the rectifier transformer in an cell-house can simply be modelled as a source of electric voltage having a constant value connected in series with a resistor. If the injected current is continuous, then the voltage that is observed in the load will be continuous.

In the load, V_{cc} and I_{cc} are, respectively, the values of the continuous voltage and current. The power in the load is:

P_{cc}(t)=V_{cc}×I_{cc}

### Electrical Quantities in the Transformer

The electric power transformer is an electrical device that can be used as an electric power converter where the power is transferred from the input to the output through the magnetic core. The relationship that defines the transformer is known as the “transformation ratio”. The transformation ratio is the quotient between the number of turns of the primary and secondary windings and has a constant value. The transformation ratio is the same value that the quotient between the incoming voltage and the outgoing voltage, or the quotient between the outgoing current and the incoming current of the transformer.

The electric power for each phase of a transformer is:

P(t)=V(t)×I(t).

If, respectively, V(t) and I(t) are the instantaneous voltage current values on coil A of the transformer and are sinusoidal functions with maximum values V and I and, moreover, are in-phase, then the instantaneous voltage and current values of phase A of the transformer can be written as:

V_{A}(t)=V×cos(ω×t) and I_{A}(t)=I×cos(ω×t)

By replacing the expressions of the instantaneous voltage and current, then the instantaneous power in phase A will be:

P_{A}(t)=V×I×cos²(ω×t)

Evidently, the instantaneous power of phases B and C will be, respectively:

P_{B}(t)=V×I×cos²(ω×t+120°) and P_{C}(t)=V×I×cos²(ω×t−120°)

Then, the total tri-phase power of the transformer will be the sum of the instantaneous power of the three phases:

P(t)=P_{A}(t)+P_{B}(t)+P_{C}(t)

By replacing the expressions, we obtain:

P(t)=V×I×[cos²(ω×t)+cos²(ω×t+120°)+cos²(ω×t−120°)]

Therefore, the total instantaneous tri-phase power that a transformer transfers will be a scalar number with a constant value equal to:

$$P ( t ) = \frac{3}{2} \times V \times {I}^{4}$$

It is possible to establish the equality between the tri-phase power and the power in the load:

$$P ( t ) = \frac{3}{2} \times V \times I = {V}_{cc} \times {I}_{cc} = {P}_{cc} ( t )$$

If the voltage and current values in the secondary coil of the transformer are desired to be established, then the expression of the tri-phase power in the secondary coil is written as:

$$P ( t ) = \frac{3}{2} \times {V}_{s} \times {I}_{s} = {V}_{cc} \times {I}_{cc} = {P}_{cc} ( t )$$

Then, the maximum value of the current in the secondary coil will be:

$${I}_{s} = \frac{2}{3} \times \frac{{V}_{cc}}{{V}_{s}} \times {I}_{cc}$$

Besides, the instantaneous voltage and current values are sinusoidal functions in phase each other, and the instantaneous value of the current of phase A of the secondary coil can be written as:

$${I}_{As} ( t ) = \frac{2}{3} \times \frac{{V}_{cc}}{{V}_{s}} \times {I}_{cc} \times cos ( ω \times t )$$

$$[ {cos}^{2} ( ω \times t ) + {cos}^{2} ( ω \times t + {120}^{°} ) + {cos}^{2} ( ω \times t - {120}^{°} ) ] = \frac{3}{2}$$

The outgoing voltage of phase A in the transformer will be:

V_{As}(t)=Vₛ×cos(ω×t)

### Electric Quantities in the Monophase Rectifier

In the monophase rectifier, the voltage and current values are basically the same as in the secondary coil of the transformer, but rectified. It is appropriate without loss of generality to refer to the positive half-cycle of the quantities of the transformer secondary in the analysis.

The outgoing voltage of the monophase rectifier of phase A in the positive half-cycle will be:

V_{Ar}(t)=Vₛ×cos(ω×t) with (ω×t)ε(−90°;90°)

The outgoing current of the monophase rectifier of phase A in the positive half-cycle will be:

$${I}_{Ar} ( t ) = \frac{2}{3} \times \frac{{V}_{cc}}{{V}_{s}} \times {I}_{cc} \times cos ( ω \times t )$$

$$with \\ ( ω \times t ) ∈ ( - 90 ° ; 90 ° )$$

The voltage V_{Ar}(t) is the instantaneous voltage that the capacitor bank presents. This bank is found at the input of the buck converter.

The current I_{Ar}(t) is the instantaneous current that the capacitor bank presents. This bank is found at the input of the buck converter.

### Electric Quantities in the Buck Converter

In the presented case, the buck converter will operate in a narrower range than the complete positive half-cycle, and defined by the inequation:

$$cos ( ω \times t ) > + \frac{{V}_{cc}}{{V}_{s}}$$

In this case, the instantaneous duty cycle is:

$${D}_{A} ( t ) = \frac{{V}_{cc}}{{V}_{Ar} ( t )} = \frac{{I}_{Ar} ( t )}{{I}_{Acc} ( t )}$$

By replacing the expression V_{Ar}(t) in the expression D_{A}(t), the instantaneous duty cycle of the buck converter for phase A is obtained:

$${D}_{A} ( t ) = \frac{{V}_{cc}}{{V}_{s} \times cos ( ω \times t )}$$

The instantaneous value of the load current given by phase A, obtained from the defining relationship of the phase A duty cycle, corresponds to:

$${I}_{Acc} ( t ) = \frac{{I}_{Ar} ( t )}{{D}_{A} ( t )}$$

By replacing the value obtained for the instantaneous duty cycle of phase A, the phase A current is:

$${I}_{Acc} ( t ) = \frac{{I}_{Ar} ( t )}{{D}_{A} ( t )} = \frac{( \frac{2}{3} \times \frac{{V}_{cc}}{{V}_{s}} \times {I}_{cc} \times cos ( ω \times t ) )}{( \frac{{V}_{cc}}{{V}_{s} \times cos ( ω \times t )} )}$$

By simplifying this expression, the following expression is obtained for the current that is supplied to the load by phase A:

$${I}_{Acc} ( t ) = \frac{2}{3} \times {I}_{cc} \times {cos}^{2} ( ω \times t )$$

It is evident that the current of phases B and C correspond to:

$${I}_{Bcc} ( t ) = \frac{2}{3} \times {I}_{cc} \times {cos}^{2} ( ω \times t + 120 ° )$$

$$and$$

$${I}_{Ccc} ( t ) = \frac{2}{3} \times {I}_{cc} \times {cos}^{2} ( ω \times t - 120 ° ) ,$$

respectively.

The total current of the load will be the sum of the continuous currents contributed by each phase:

$$\begin{matrix}{I}_{Acc} ( t ) + {I}_{Bcc} ( t ) + {I}_{Ccc} ( t ) = \frac{2}{3} \times {I}_{c} \times ( {cos}^{2} ( ω \times t ) + \\ {cos}^{2} ( ω \times t + 120 ° ) + {cos}^{2} ( ω \times t - 120 ° ) ) \\ = {I}_{cc}\end{matrix}$$

Thus, the voltage buck converter, operating with a duty cycle as a function of the instantaneous voltage in the secondary coil, produces a sinusoidal current for the three transformer phases and a continuous current in the load. This constitutes a mathematical demonstration that the invention that is claimed is possible to construct in the range in which the instantaneous outgoing voltage of the transformer is higher than the voltage in the load.

### Electric Quantities in the Boost Converter

In the present case, the boost converter will operate in the range in which the voltage buck converters do not operate. This is a narrower range than the complete positive half-cycle, defined by the inequation:

$$cos ( ω \times t ) < \frac{{V}_{cc}}{{V}_{s}}$$

In this case, the instantaneous duty cycle is:

$${D}_{A} ( t ) = 1 - \frac{{V}_{Ar} ( t )}{{V}_{cc}} = 1 - \frac{{I}_{Acc} ( t )}{{I}_{Ar} ( t )}$$

By replacing the expression V_{Ar}(t) in the expression D_{A}(t), the instantaneous duty cycle of the buck converter of phase A is obtained:

$${D}_{A} ( t ) = 1 - \frac{{V}_{s} \times cos ( ω \times t )}{{V}_{cc}}$$

The instantaneous value of the current that flows in the load contributed by phase A, obtained from the defining relationship of the duty cycle in phase A, corresponds to:

I_{ACC}(t)=(1−D_{A}(t))×I_{Ar}(t)

By simplifying, the current that is supplied to the load by phase A is:

$${I}_{Acc} ( t ) = \frac{2}{3} \times {I}_{cc} \times {cos}^{2} ( ω \times t )$$

It is evident that the currents of phases B and C corresponds to:

$${I}_{Bcc} ( t ) = \frac{2}{3} \times {I}_{cc} \times {cos}^{2} ( ω \times t + 120 ° )$$

$$and$$

$${I}_{Ccc} ( t ) = \frac{2}{3} \times {I}_{cc} \times {cos}^{2} ( ω \times t - 120 ° ) ,$$

respectively.

The total current supplied to the load will be the sum of the continuous currents contributed by each phase:

$$\begin{matrix}{I}_{Acc} ( t ) + {I}_{Bcc} ( t ) + {I}_{Ccc} ( t ) = \frac{2}{3} \times {I}_{c} \times ( {cos}^{2} ( ω \times t ) + \\ {cos}^{2} ( ω \times t + 120 ° ) + {cos}^{2} ( ω \times t - 120 ° ) ) \\ = {I}_{cc}\end{matrix}$$

According to the topology presented (FIGS. 3 and/or 4), the current of the boost converter must circulate through the buck converter, which should be turned on in order to the current flows correctly.

Thus, the voltage boost converter, operating with a variable duty cycle as function of the instantaneous secondary-coil voltage, produces sinusoidal currents in the three transformer phases and continuous currents in the load. This constitutes a mathematical demonstration that the invention claimed can be constructed in the range in which the instantaneous outgoing voltage of the transformer is lower than the voltage in the load.

### Technical Aspects of Design and Construction

The fact that the instantaneous tri-phase power is constant is the technical justification for the construction of the existing devices, i.e, multipulse rectifier transformers. As the number of pulses of the rectifier transformer increases, the harmonic components of the primary current decrease and the ripple of the continuous outgoing current decreases. However, the construction of multipulse systems implies the design and fabrication of complex and expensive transformers that must withstand non-sinusoidal magnetic flows and non-sinusoidal secondary currents. The emphasis of the invention is on the simplification of the transformers design. The reduction of the harmonic components in the network and, therefore, the elimination of the need for external filters are additional positive consequences.

Nowadays, the implementation of more complex rectifiers and, at the same time, simpler and less expensive transformers is justified. Of course, in the future, this dilemma will be easier to solve with the appearance of power semiconductors for higher currents, higher voltages, higher operational frequency, and lower costs.

The controlled electric current rectifier transformer with sinusoidal input and continuous output, is made up of a generic electronic power elements such as electronic gates, diodes, capacitors, and inductors. With the proposed solution, a process problem that previously had no equivalent solution is solved.

The use of common components in the controlled rectifier transformer with sinusoidal input and continuous output guarantees that the process can be implemented on an industrial scales.

The typical current levels in the cell-houses are normally higher than in practically any other type of industrial process. Therefore, the design of the devices will normally be based on multiple elemental devices connected in parallel, especially voltage buck converters. The use of parallel elements requires the overlapping of the turning on elemental converter switches. This decreases the capacity value of the capacitors and improves the condition of the resultant waveforms. It also results in a higher frequency for the current and voltage ripple.

In special applications in which the secondary-coil voltage of the transformer is noticeably greater than the continuous outgoing voltage, it will not be necessary to incorporate the voltage boost converter and its respective star rectifier device (FIG. 10, 11). Thus, the currents and magnetic flows of the transformer will be approximately sinusoidal; the outgoing currents of each phase delivered by the converter will be approximately proportional to squared sinusoidals and, therefore, the total outgoing current will be an approximately constant direct current.

### FIGURES

FIG. 1: Double-star rectifier transformer with an interface reactor with ANSI 45 and ANSI 46 transformers. This is the typical configuration that is currently used to implement rectifier transformers for electrowinning processes or the electrorefining of copper and other products. Completely controlled.

FIG. 2: AFE (Active Front End) rectifier transformer with sinusoidal voltages, currents, and flows. Voltage boost converter. Not completely controlled. When the voltage in the load is low enough, it behaves as a conventional diode bridge, generating harmonic components in the flows and currents.

FIG. 3: Controlled rectifier transformer with sinusoidal input and continuous output for cell-houses with a monophase rectifier in a bridge configuration.

FIG. 4: Controlled rectifier transformer with sinusoidal input and continuous output for cell-houses with a monophase rectifier in a star configuration.

FIG. 5: Elemental voltage buck converter. (a) General configuration. (b) Configuration with IGBT transistors.

FIG. 6: Elemental voltage boost converter. (a) General configuration. (b) Configuration with IGBT transistors.

FIG. 7: Diagram of operation time for (a) voltage buck converters and (b) voltage boost converters.

FIG. 8: Controlled rectifier transformer with sinusoidal input and continuous output for cell-houses with a monophase rectifier in a bridge configuration and a voltage buck converter with elemental components in parallel for high current loads.

FIG. 9: Controlled rectifier transformer with sinusoidal input and continuous output for cell-houses with a monophase rectifier in a star configuration and a voltage buck converter with elemental components in parallel for high current loads.

FIG. 10: Controlled rectifier transformer with sinusoidal input and continuous output for cell-houses with a monophase rectifier in a bridge configuration without a boost converter and without the corresponding star rectifier.

FIG. 11: Controlled rectifier transformer with sinusoidal input and continuous output for cell-houses with a monophase rectifier in a star configuration without a boost converter and without the corresponding star rectifier.

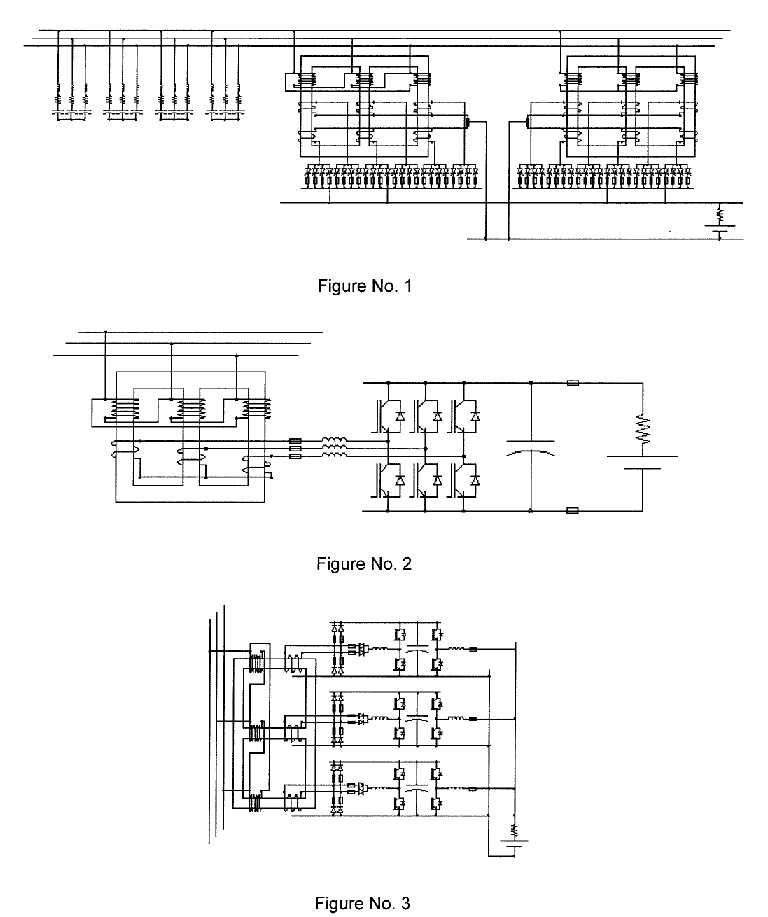

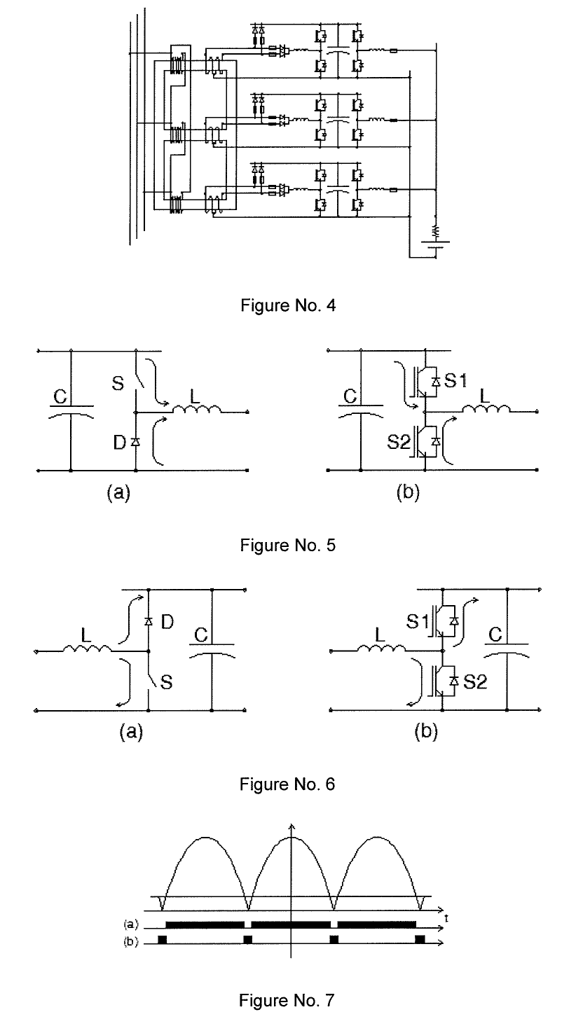

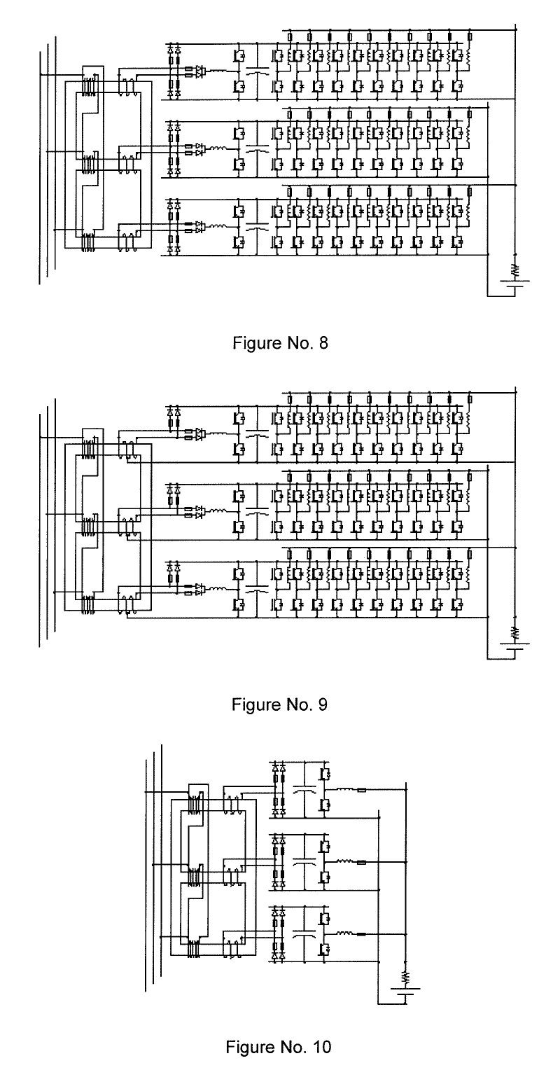

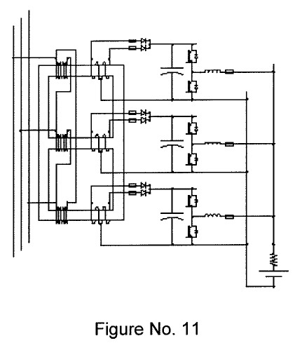

1. A device to transform and rectify electrical current, which supplied from a three-phase alternating current supply is able to supply power to any load, wherein it includes:
a) a tri-phase transformer where each and every secondary windings has its terminals available to connect;
b) a set of three full wave mono-phase rectifiers connected to their respective secondary windings (a) to supply power to
c) a set of three boost converters to supply power to
d) a set of three capacitor banks;
e) a set of three full wave mono-phase rectifiers connected to their respective secondary windings (a) to supply power their respective capacitor banks (d) and
f) a set of three buck converters supplied from their respective capacitor banks and with its three outputs connected in parallel to supply power to the load.

2. A device as presented in claim 1, wherein it produces continuous current to the load and sinusoidal input current in each and every winding of the transformer with the following procedure:
I) in the period of time when voltage in one or more of the three secondary windings is lower than the load voltage, the respective boost converter (1.c) produces, by means pulse width modulation:
a) sinusoidal current flowing towards its respective secondary winding (1.a) mono-phase rectifier (1.b), and
b) squared-sinusoidal output current to supply power to its respective capacitor bank (1.d) and buck converter (1.f);
II) in the period of time when the voltage in one or more of the secondary windings is higher than the load voltage, the respective buck converter (1.e) produces, by means pulse width modulation,
a) sinusoidal current flowing towards its respective secondary winding and mono-phase rectifier (1.d), and
b) squared sinusoidal output current to supply power to the load;
III) The sum of output currents flowing towards the load, produced by each of the buck converters (1.e), which are 120° out-of-phase each other, is a continuous current with constant value.

3. A device as presented in the previous claims wherein the voltage in the secondary windings is high enough that is not necessary to include neither mono-phase rectifiers (1.b) nor boost converters (1.c) to produce continuous current flowing towards the load by means the following procedure:
I) in the period of time when the voltage in one or more of the secondary windings is lower than the load voltage, no current is produced by the respective converter.
II) in the period of time when the voltage in one or more of the secondary windings is higher than the load voltage, the respective buck converter (1.f) produces, by means pulse width modulation
a) sinusoidal current flowing towards its respective transformer secondary winding (1.a) and mono-phase rectifier (1.d), and
b) squared-sinusoidal output current to supply power to the load;
III) The sum of output currents flowing towards the load, produced by each of the buck converters (1.e), which are 120° out-of-phase each other, is a continuous current with approximately constant value.

4. A device as presented in the previous claims wherein the transformer (1.a) described is a set of three mono-phase transformers.

5. A device as presented in the previous claims wherein secondary windings of the described transformer (1.a) their main terminals available, the mono-phase rectifiers (1.b) which supply power to their respective boost converters (1.c) are connected either as Graetz bridge or as wye and the mono-phase rectifiers (1.e) which supply power directly to their respective buck converters (1.f) are connected as Graetz bridge.

6. A device as presented in the previous claims wherein secondary windings in the described transformer (1.a) have their both main and midpoint terminals available, the mono-phase rectifiers (1.b) which supply power to their respective boost converters (c) are connected as wye and the mono-phase rectifiers (1.d) which supply power directly to their respective buck converters (f are connected as wye.

7. A device as presented in the previous claims wherein mono-phase rectifiers (1.b and 1.c) include two or more rectifier elements connected in parallel.

8. A device as presented in the previous claims wherein buck converters (1.f) include two or more buck converters connected in parallel.

9. A device as presented in the previous claims wherein boost converters (1.c) include two or more boost converters connected in parallel.

10. A device as presented in the previous claims wherein capacitor banks (1.d) include two or more capacitors connected in parallel.
